(19) United States
(12) Patent Application Publication
(10) Pub. No.: US 2018/0297803 A1
(43) Pub. Date: Oct. 18, 2018

(54) PAPER SHEET TRANSPORTATION MECHANISM AND PAPER SHEET HANDLING DEVICE

(71) Applicant: FUJITSU FRONTECH LIMITED, Tokyo (JP)

(72) Inventors: Mitsutaka Nishida, Inagi (JP); Hayato Minamishin, Inagi (JP); Naoto Ikeda, Inagi (JP)

(21) Appl. No.: 16/012,991

(22) Filed: Jun. 20, 2018

Related U.S. Application Data
(63) Continuation of application No. PCT/JP2016/052214, filed on Jan. 26, 2016.

(51) Int. Cl. B65H 5/38; B65H 29/70; B65H 5/02; G07D 11/00

(52) U.S. Cl. CPC B65H 5/38; G07D 11/003; B65H 5/025; B65H 29/70

(57) ABSTRACT

A paper sheet transportation mechanism includes: transportation portions between which a paper sheet is sandwiched so as to transport the paper sheet; and a transportation guide that protrudes in a direction of the paper sheet sandwiched by the transportation portions such that the paper sheet is deformed into a wave shape in a cross section perpendicular to a transportation direction of the paper sheet, and that extends in the transportation direction.

### CROSS-REFERENCE TO RELATED APPLICATION

This application is continuation application of International Application PCT/JP2016/052214 filed on Jan. 26 2016 and designated the U.S., the entire contents of which are incorporated herein by reference.

### TECHNICAL FIELD

The embodiments discussed herein are related to a paper sheet transportation mechanism that transports a paper sheet and to a paper sheep handling device that includes the paper sheet transportation mechanism.

### BACKGROUND ART

Conventionally, a paper sheet handling device such as an automated teller machine (ATM) includes a paper sheet transportation mechanism that transports paper sheets such as bills, securities, and checks. For example, belts, rollers, or a combination of them are mainly used in this paper sheet transportation mechanism as a device that transports a paper sheet.

With respect to the paper sheet transportation mechanism described above, a technology is known that brings a brush into point-contact with a bill transported by a pair of transportation portions that are rollers or belts so that a portion of the bill has a wave shape (see, for example, Japanese Laid-Open Patent Publication No. 10-129915).

A paper sheet information acquisition device is known that acquires magnetic information on a paper sheet partly deformed into a wave shape, in which the deformation is created due to a detection portion of a magnetic information acquisition device being concave to a transportation surface of the paper sheet (see, for example, Japanese Laid-open Patent Publication No. 2004-54809).

### SUMMARY OF THE INVENTION

In one aspect, a paper sheet transportation mechanism includes: transportation portions between which a paper sheet is sandwiched so as to transport the paper sheet; and a transportation guide that protrudes in a direction of the paper sheet sandwiched by the transportation portions such that the paper sheet is deformed into a wave shape in a cross section perpendicular to a transportation direction of the paper sheet, and that extends in the transportation direction.

In another aspect, a paper sheet handling device includes a paper sheet transportation mechanism that includes transportation portions between which a paper sheet is sandwiched so as to transport the paper sheet; and a transportation guide that protrudes in a direction of the paper sheet sandwiched by the transportation portions such that the paper sheet is deformed into a wave shape in a cross section perpendicular to a transportation direction of the paper sheet, and that extends in the transportation direction.

### BRIEF DESCRIPTION OF THE DRAWINGS

FIG. 1 is a cross-sectional view of an internal structure of a major portion of a paper sheet handling device according to an embodiment of the present invention;

FIG. 2 is a cross-sectional view of a paper sheet transportation mechanism according to the embodiment of the present invention, wherein the cross section is perpendicular to a transportation direction;

FIG. 3 is a cross-sectional view of an internal structure of the paper sheet transportation mechanism with a paper sheet deformed into a wave shape according to the embodiment of the present invention;

FIG. 4 is a cross-sectional view of the paper sheet transportation mechanism with the paper sheet deformed into a wave shape according to the embodiment of the present invention, wherein the cross section is perpendicular to the transportation direction;

FIG. 5 is a plan view of the internal structure of the paper sheet transportation mechanism with a paper sheet according to the embodiment of the present invention;

FIG. 6 is a schematic perspective view of an upper guiding plate and a lower guiding plate according to the embodiment of the present invention;

FIG. 7A is a perspective view of a flat paper sheet (before it is deformed into a wave shape) according to the embodiment of the present invention;

FIG. 7B is a perspective view of the paper sheet in the process of being deformed into a wave shape according to the embodiment of the preset invention;

FIG. 7C is a perspective view of the paper sheet that has been deformed into a wave shape according to the embodiment of the present invention;

FIG. 8A illustrates an operation of drawing out a paper sheet that is performed in the paper sheet handling device according to the embodiment of the present invention (part 1);

FIG. 8B illustrates the operation of drawing out a paper sheet that is performed in the paper sheet handling device according to the embodiment of the present invention (part 2);

FIG. 8C illustrates the operation of drawing out a paper sheet that is performed in the paper sheet handling device according to the embodiment of the present invention (part 3);

FIG. 8D illustrates the operation of drawing out a paper sheet that is performed in the paper sheet handling device according to the embodiment of the present invention (part 4);

FIG. 8E illustrates the operation of drawing out a paper sheet that is performed in the paper sheet handling device according to the embodiment of the present invention (part 5);

FIG. 9 is a cross-sectional view of an internal structure of a paper sheet transportation mechanism with a paper sheet deformed into a wave shape according to a modification of the embodiment of the present invention; and

FIG. 10 is a cross-sectional view of the paper sheet transportation mechanism with the paper sheet deformed into a wave shape according to the modification of the embodiment of the present invention, wherein the cross section is perpendicular to the transportation direction.

### EMBODIMENTS

In particular, when a paper sheet is, for example, a worn-out bill that is not sufficiently stiff to be transported (that is, it is soft) while taking into consideration the overall size of the bill, or when the paper sheet is transported at high speed, the paper sheet may be jammed or may proceed obliquely because a wind pressure occurs in a direction opposite to the transportation direction or because a curled portion of the paper sheet such as a turned-up forward end of the paper sheet has an angle such that it comes into contact with a guiding surface.

Further, in the case of the paper sheet transportation mechanism described above that brings a brush into point-contact with a paper sheet so that the paper sheet has a wave shape, the paper sheet transportation mechanism has a complicated structure. In addition to that, the paper sheet is easily subjected to a wind pressure that occurs in a direction opposite to the transportation direction and it is not possible to prevent the paper sheet from having an angle such that it comes into contact with a guiding surface, because only a portion of the paper sheet has a wave shape.

A paper sheet transportation mechanism and a paper sheet handling device according to embodiments of the present invention will now be described with reference to the drawings.

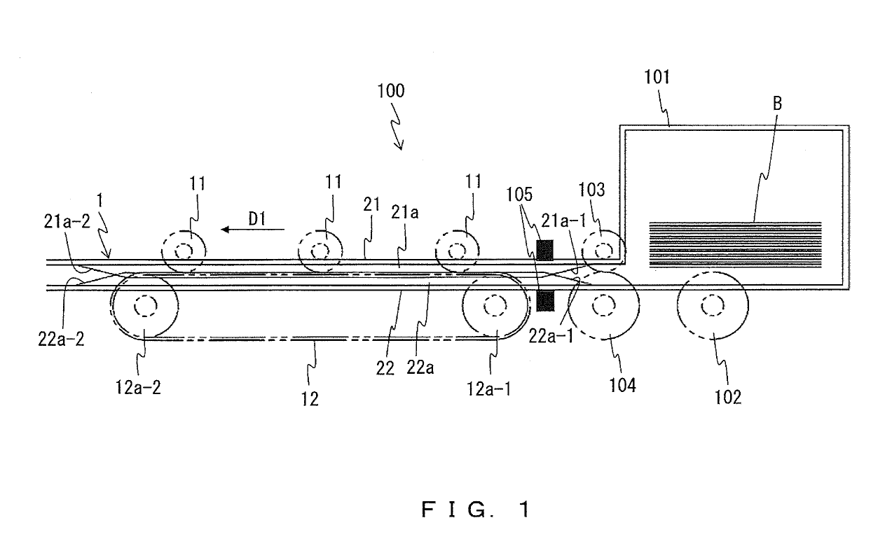

FIG. 1 is a cross-sectional view of an internal structure of a major portion of a paper sheet handling device 100 according to an embodiment of the present invention.

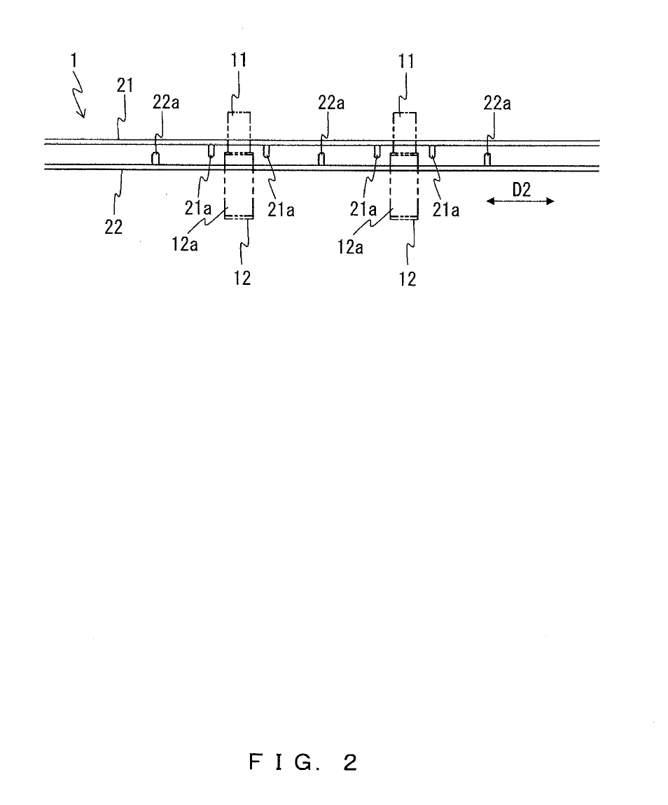

FIG. 2 is a cross-sectional view of a paper sheet transportation mechanism 1 according to the embodiment of the present invention, wherein the cross section is perpendicular to a transportation direction D1 of a paper sheet B.

The paper sheet handling device 100 illustrated in FIG. 1 includes the paper sheet transportation mechanism 1, a storage 101, a pick roller 102, draw rollers 103 and 104, and a passage detection sensor 105. The paper sheet handling device 100 is just an example of an automated teller machine (ATM) or a unit that incorporated into the ATM and transports a paper sheet B. Examples of the paper sheets B are bills, securities, and checks.

For example, the storage 101 stores paper sheets B stacked on top of each other.

The pick roller 102 is arranged in the lower part of the storage 101 and transports a lowermost paper sheet B in the stacked paper sheets B to the outside of the storage 101.

The draw rollers 103 and 109 are arranged to face each other, and draw out a paper sheet B from the storage 101 so as to transport the paper sheet B to the paper sheet transportation mechanism 1.

The passage detection sensor 105 detects the passage of a paper sheet B drawn out from the storage 101 by, for example, a well-known optical method.

As illustrated in FIGS. 1 and 2, the paper sheet transportation mechanism 1 includes a plurality of transportation rollers 11, a pair of transportation belts 12, an upper guiding plate 21, and a lower guiding plate 22. In FIG. 1, the upper guiding plate 21, the lower guiding plate 22, and the storage 101 are configured to be one component, but they may be separate components.

The transportation rollers 11 are arranged in pairs in each of the three locations in the transportation direction D1 of a paper sheet B, wherein the paired transportation rollers 11 are arranged in a width direction D2 of the paper sheet B that is illustrated in FIG. 2. As described, six transportation rollers 11 are provided in the present embodiment.

The transportation belts 12 are arranged in pairs in the width direction D2, and each transportation belt 12 and corresponding three transportation rollers 11 sandwich a paper sheet B between them. The transportation belt 12 is bridged between pulleys 12a-1 and 12a-2, which are situated at different ends in the transportation direction D1, and makes a circuit such that an upper portion of the transportation belt 12 that comes into contact with the paper sheet B moves in the transportation direction D1.

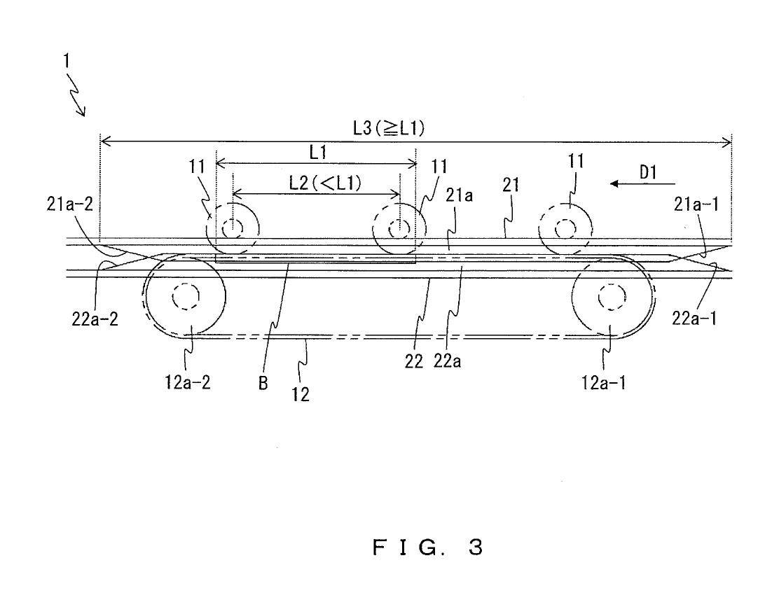

Here, the plurality of transportation rollers 11 and the pair of transportation belts 12 are examples of transportation portions that sandwich a paper sheet B be them so as to transport the paper sheet B. The transportation portions may be a pair of transportation rollers 11 arranged to face each other that sandwich a paper sheet B between them so as to transport the paper sheet B, or the transportation unit may be a pair of transportation belts 12 arranged to face each other that sandwich a paper sheet B between them so as to transport the paper sheet B. It is preferable that, as illustrated in FIG. 3, each of the intervals (length L2) at which the transportation rollers 11 are arranged in the transportation direction D1 be shorter than a length L1 of a paper sheet B sandwiched between the transportation rollers 11 and the transportation belt 12 in the transportation direction D1 (L2<L1) in order to stably transport the paper sheet B.

As illustrated in FIG. 2, the upper guiding plate 21 and the lower guiding plate 22 are arranged to face each other. A paper sheet B is transported through a space between the upper guiding plate 21 and the lower guiding plate 22. Openings (not illustrated) are formed in the upper guiding plate 21 and the lower guiding plate 22 in order to prevent the upper guiding plate 21 and the lower guiding plate 22 from interfering with the transportation rollers 11 and the transportation belts 12. The transportation rollers 11 and the transportation belt 12 pass through the respective openings to sandwich the paper sheet B between them.

The upper guiding plate 21 includes a rib 21a that extends in the transportation direction D1, and the lower guiding plate 22 includes a rib 22a that extends in the transportation direction D1.

It is preferable that, as illustrated in FIG. 3, the rib 21a and the rib 22a each extend, in the transportation direction D1, over a range having a length equal to or longer than the length L1 of a paper sheet B, that is, that L3 (the length of the rib 21a, 22a)≥L1 (the length of the paper sheet B) be satisfied. Further, it is more preferable that the ribs 21a and 22a each extend, in the transportation direction D1, over an entire region in which the three pairs of transportation rollers 11 or the pair of transportation belts 12 are arranged in the transportation direction D1 (a region between a forward-end transportation roller 11 and a rear-end transportation roller 11 in the transportation direction D or a region between a forward end and a rear end of the transportation belt 12 in the transportation direction D1).

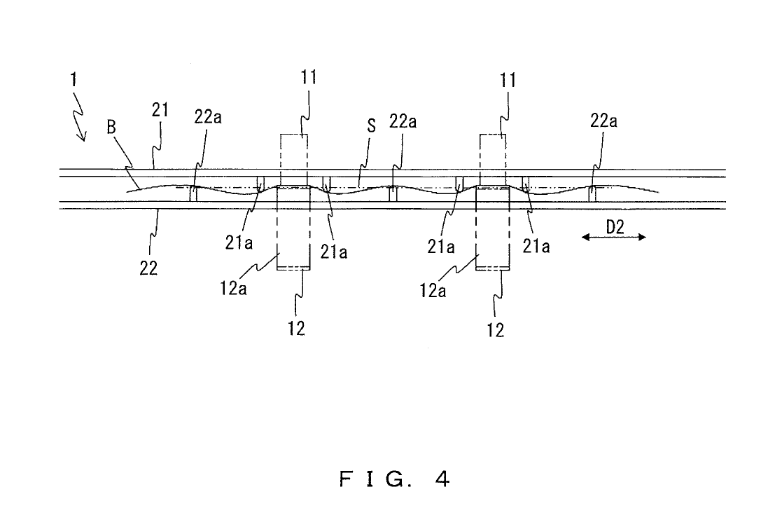

The rib 21a of the upper guiding plate 21 is an example of a first transportation guide that protrudes in a direction of a paper sheet B from one side (an upper side in FIG. 4) in a cross section illustrated in FIG. 4 (that is perpendicular to the transportation direction D1), the paper sheet B being situated between the one side and the other side (a lower side in FIG. 4) in the cross section illustrated in FIG. 4. The rib 22a of the lower guiding plate 22 is an example of a second transportation guide that protrudes in the direction of the paper sheet B from the other side in the cross section illustrated in FIG. 4. The rib 21a and the rib 22a protrude as described above so as to deform the paper sheet B sandwiched between the transportation rollers 11 and the transportation belts 12 into a wave shape in the cross section illustrated in FIG. 4. Here, the paper sheet B is considered to be deformed into a wave shape if the paper sheet B has at least one convex portion formed by curving the surface of the paper sheet B. Further, there is no need to arrange the ribs 21a and 22a (the transportation guides) near the storage 101 illustrated in FIG. 1, and it is sufficient if they are arranged at arbitrary locations on a route to transport the paper sheet B.

It is preferable that the rib 21a and the rib 22a be configured to be respectively integral with the upper guiding plate 21 and the lower guiding plate 22, in order to not increase the number of components. Further, it is preferable that, in the cross-sectional view illustrated in FIG. 2, surfaces (ends) of the ribs 21a and 22a that come into contact with a paper sheet B be curved in a semicircle, in order to reduce friction that occurs between these ribs and the paper sheet B. The material of the ribs 21a and 22a (the upper guiding plate 21 and the lower guiding plate 22) is, for example, synthetic resin, but is not limited to synthetic resin and may be metal.

It is preferable that a plurality of ribs 21a of the upper guiding plate 21 and a plurality of ribs 22a of the lower guiding plate 22 be arranged in the width direction D2. In the example of FIG. 4, four ribs 21a of the upper guiding plate 21 are arranged in the width direction D2, wherein each two of the four ribs 21a are situated across a corresponding one of the paired transportation rollers 11 from each other in the width direction D2. Three ribs 22a of the lower guiding plate 22 are arranged in the width direction D2, wherein one of the three ribs 22a is situated Midway between the paired transportation belts 12 in the width direction D2, and two of the three ribs 22a are situated closer to two ends in the width direction D2 than the two outermost of the ribs 21a. Further, the ribs 21a are arranged within a region situated between a pair of transportation rollers 11 and outside of this region, and the ribs 22a are arranged within a region situated between a pair of transportation belts 12 and outside of this region.

It is preferable that at least some of the ribs 21a of the upper guiding plate 21 and at least some of the ribs 22a of the lower guiding plate 22 be arranged alternately with each other in the width direction D2 within a certain range. As illustrated in FIG. 4, all of the ribs 21a of the upper guiding plate 21 are situated between the two outermost of the ribs 22a of the lower guiding plate 22, and the rib 22a situated midway between the paired transportation belts 12 is situated between a plurality of ribs 21a of the upper guiding plate 21 in the width direction D2.

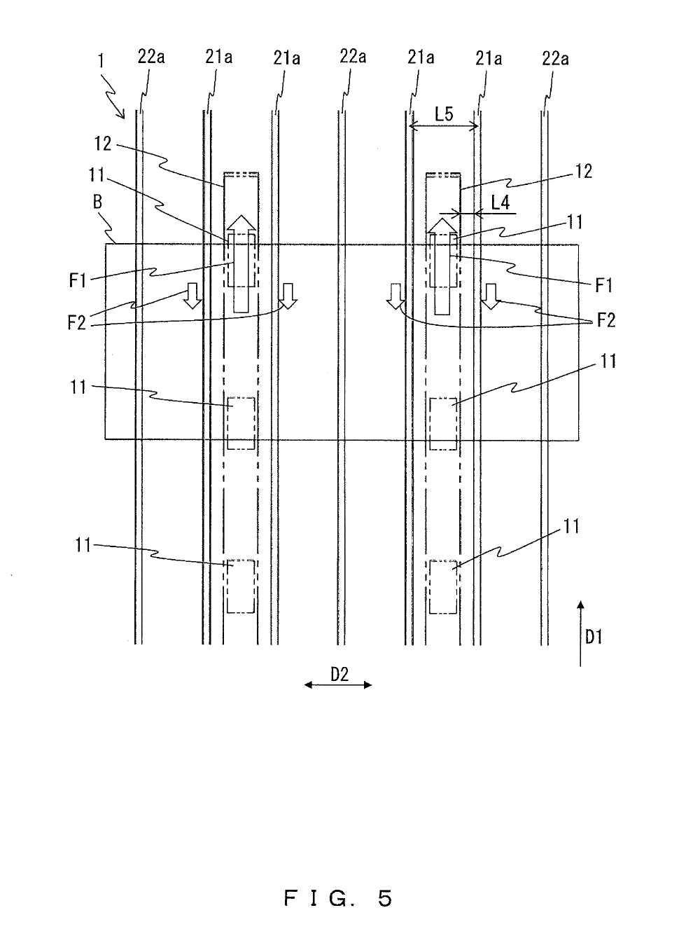

As illustrated in FIG. 5, a paper sheet B is subject to a transportation force F1 in the transportation direction D1 that is produced by the transportation rollers 11 and the transportation belts 12, and is subject to a frictional force F2 in a direction opposite to the transportation direction D1 by coming into contact with the ribs 21a and 22a. It is preferable that the four ribs 21a be arranged to have the same distance (length L4) to the transportation belt 12, in order to not tilt the direction of the frictional force F2 to the width direction D2.

It is preferable that two adjacent ribs be spaced equally (length L5) regardless of whether the adjacent ribs are two ribs 21a of the upper guiding plate 21, or two ribs 22a of the lower guiding plate 22, or a rib 21a of the upper guiding plate 21 and a rib 22a of the lower guiding plate 22, in order to deform a paper sheet B into a constant wave shape.

It is preferable that the number of portions between which a paper sheet B is sandwiched be smaller and the area of the sandwiching portions be smaller in order to make a structure simpler and to reduce costs, the sandwiching portions exerting the transportation force F1 on the paper sheet B and being constituted of the transportation rollers 11 and the transportation belts 12. However, if the number of sandwiching portions is smaller and the area of the sandwiching portions is smaller, a forward end of the paper sheet B is more likely to be curled, such as being turned up. In FIG. 5, a longitudinal direction of the paper sheet B is aligned parallel to the width direction D2 so as to increase the number of paper sheets B transported (the number of paper sheets B on which transportation processing is performed) per hour, which results in using fewer sandwiching portions (four portions), compared to when the longitudinal direction of the paper sheet B is aligned parallel to the transportation direction D1 (six portions).

It is preferable that the rib 21a of the upper guiding plate 21 and the rib 22a of the lower guiding plate 22 protrude in a direction of a paper sheet B beyond a virtual plane S (FIG. 4), including a sandwiching plane in which the paper sheet B is sandwiched between the transportation rollers 11 and the transportation belts 12. In other words, it is preferable that the rib 21a and rib 22a pass through the virtual plane S. The rib 21a of the upper guiding plate 21 or the rib 22a of the lower guiding plate 22 may protrude beyond the virtual plane S, or some of a plurality of ribs 21a or some of a plurality of ribs 22a may protrude beyond the virtual plane S.

As illustrated in FIG. 3, the rib 21a has tapered portions 21a-1 and 21a-2 formed at two ends in the transportation direction D1, and the rib 22a has tapered portions 22a-1 and 22a-2 formed at the two ends in the transportation direction D1. The tapered portions 21a-1 and 21a-2 are formed such that the protrusion of the rib 21a becomes smaller toward the two ends, and the tapered portions 22a-1 and 22a-2 are formed such that the protrusion of the rib 22a becomes smaller toward the two ends.

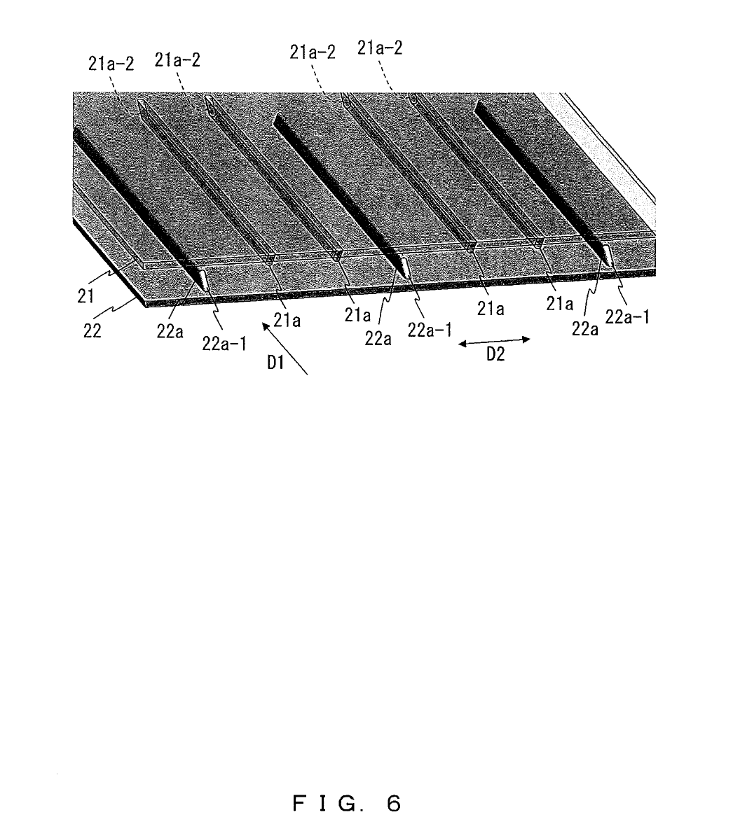

The tapered portions of the rib 21a and the rib 22a may be only the tapered portions 21a-2 of the rib 21a provided at the forward end in the transportation direction D1 and the tapered portions 22a-1 of the rib 22a provided at the rear end in the transportation direction D1, as illustrated in FIG. 6. Further, if the tapered portions of the rib 21a and the rib 22a are formed only at the rear end in the transportation direction D1, it will be easier to receive a paper sheet B transported in the transportation direction D1. However, it is preferable that the tapered portions 21a-1, 21a-2, 22a-1, and 22a-2 be formed at the ends in the transportation direction D1, for example, when a paper sheet B is to be stored in the storage 101 illustrated in FIG. 1, because the direction to transport a paper sheet B is opposite to the transportation direction D1 in which a paper sheet B is drawn out from the storage 101.

Next, an operation of drawing out a paper sheet B that is performed in the paper sheet handling device 100 is described.

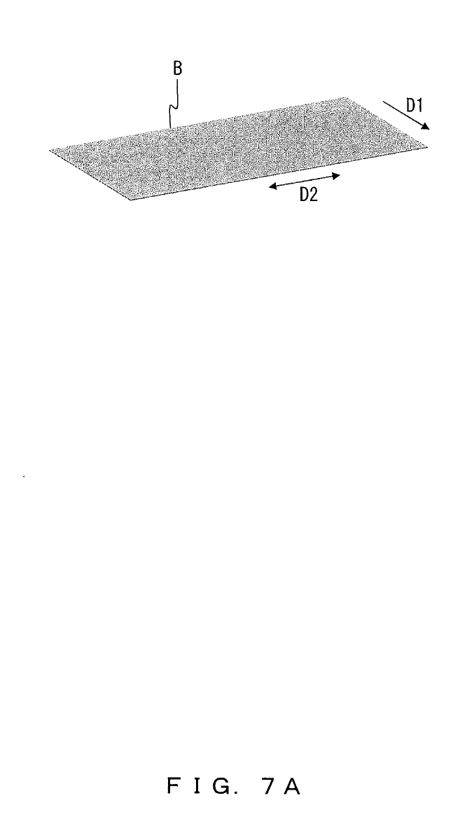

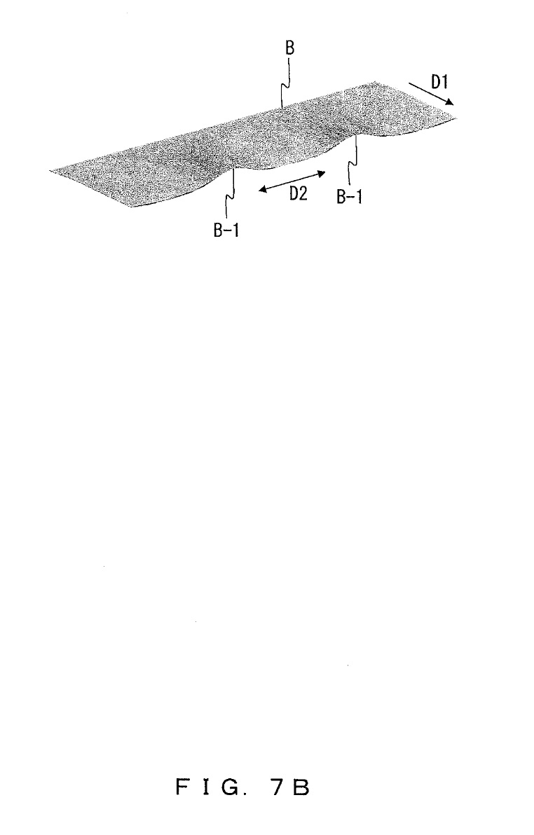

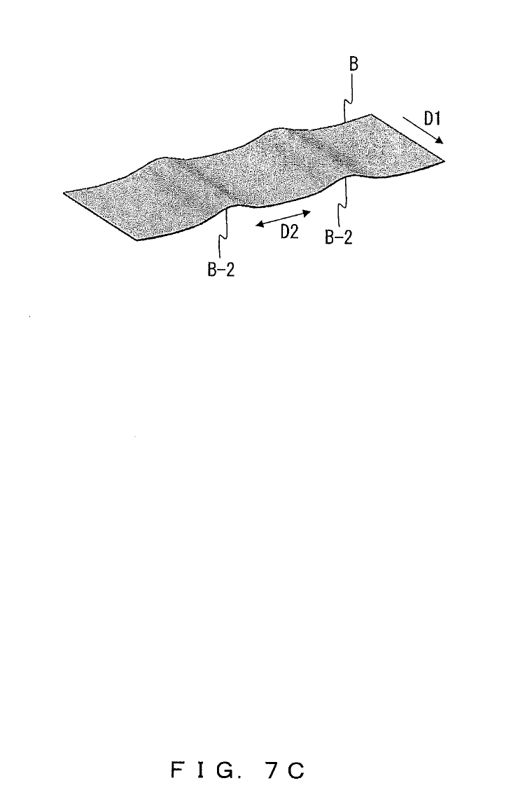

FIGS. 7A to 7C are perspective views of a paper sheet B.

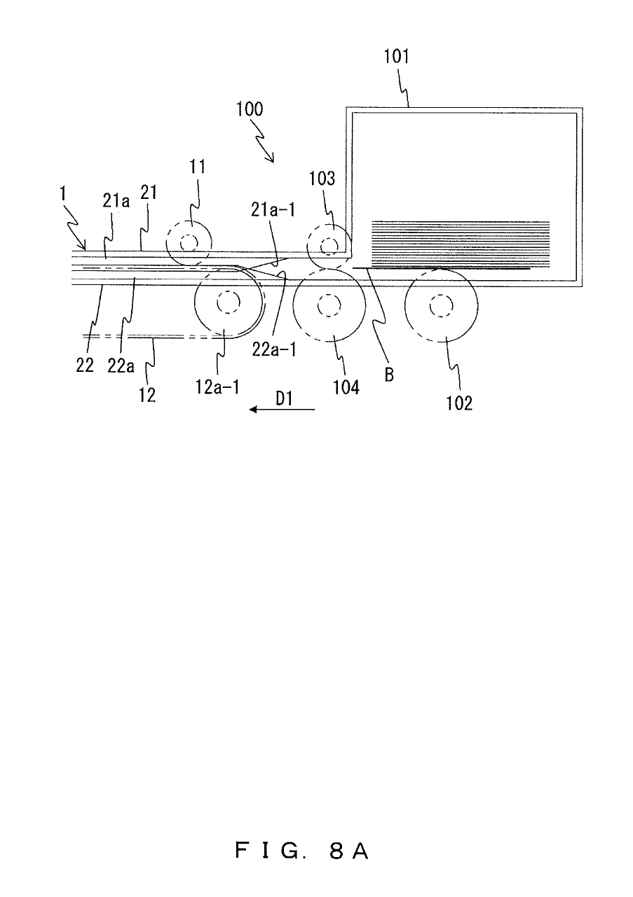

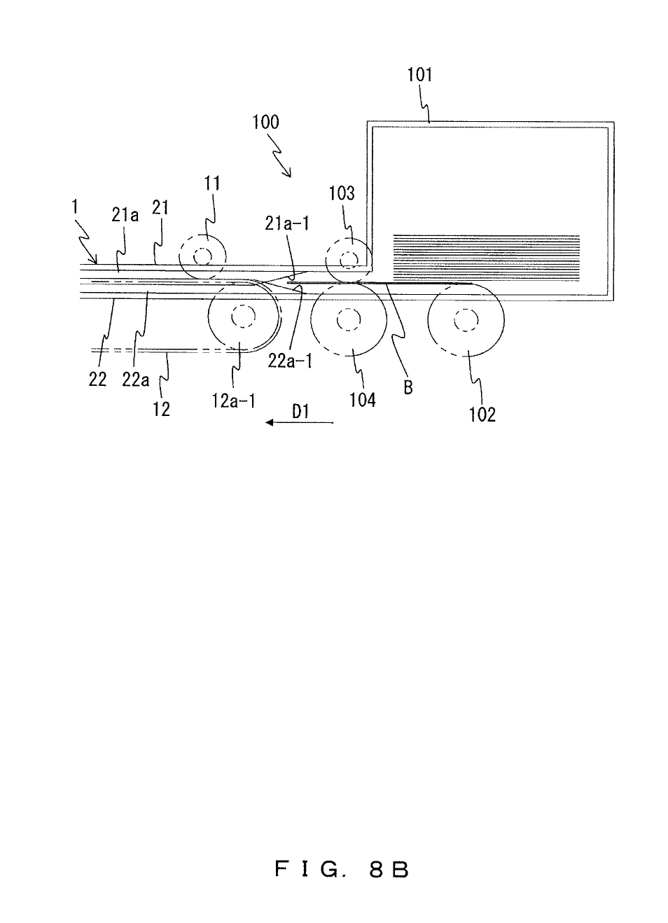

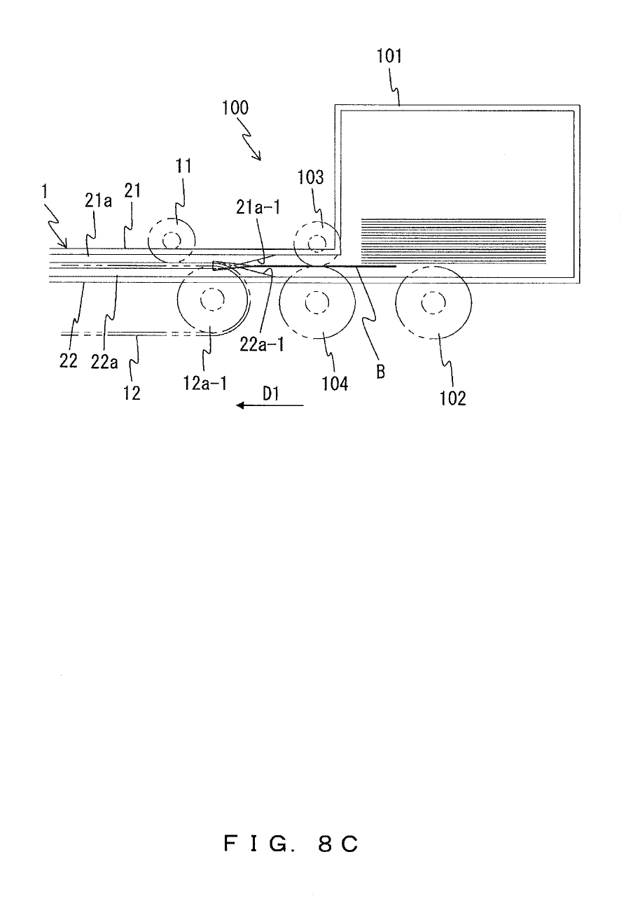

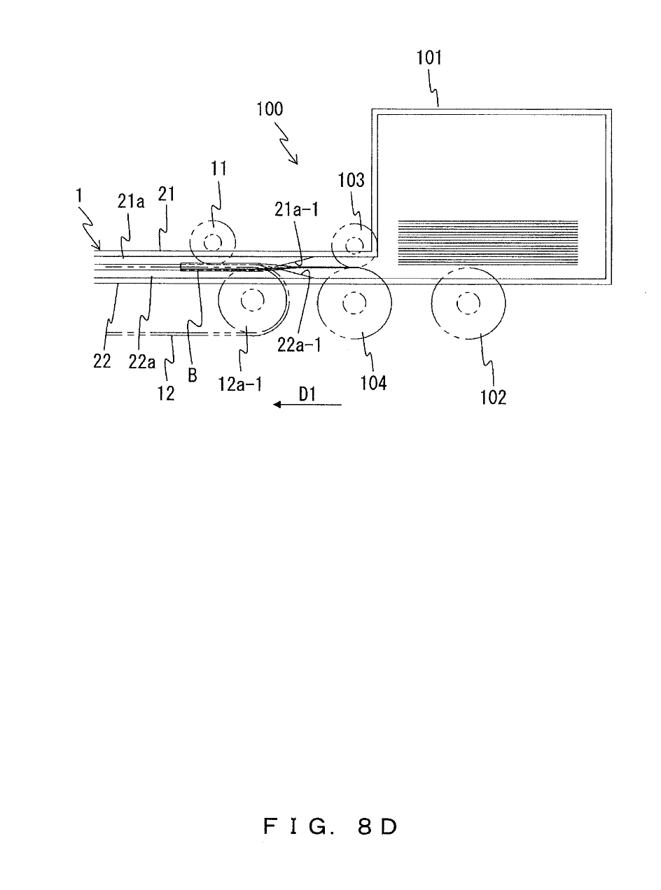

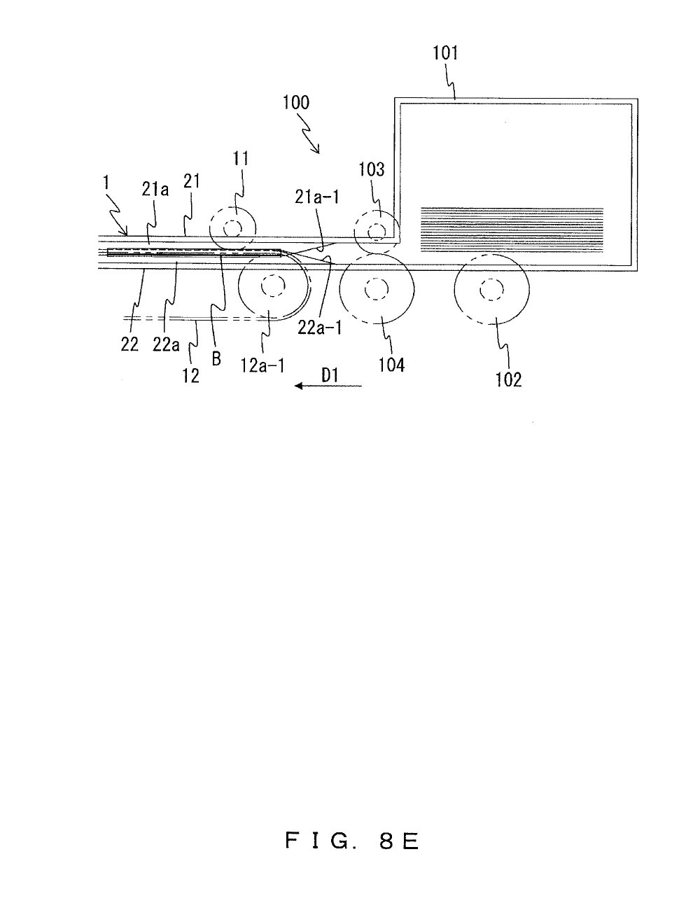

FIGS. 8A to 8E illustrate the operation of drawing out a paper sheet B that is performed in the paper sheet handling device 100. The passage detection sensor 105 illustrated in FIG. 5 is not illustrated in FIGS. 8A to 8E, but the passage of a paper sheet B is detected by the passage detection sensor 105.

First, as illustrated in FIG. 8A, the pick roller 102 arranged under the storage 101 transports a lowermost paper sheet B stacked paper sheets B to toe outside of: the storage 101.

Next, as illustrated, in FIG. 8B, the draw rollers 103 and 104 arranged to face each other draw out the paper sheet B from the storage 101 so as to transport the paper sheet B to the paper sheet transportation mechanism 1.

Next, as illustrated in FIG. 8C, when a portion of the paper sheet B enters a region in which the ribs 21a and 22a are arranged, the paper sheet B that is flat as illustrated in FIG. 7A is gradually deformed into a wave shape from the forward end in the transportation direction D1, as illustrated in FIG. 7B (see convex portions indicated by B-1).

Next, as illustrated in FIG. 8D, the entire paper sheet B has been drawn out from the storage 101. After that, as illustrated in FIG. 8E, when the entire paper sheet B has entered the region in which the ribs 21a and 22a are arranged, the entire paper sheet B has been deformed into a wave shape in the transportation direction D1, as illustrated in FIG. 7C (see convex portions indicated by B-2).

In the present embodiment described above, the transportation rollers 11 and the transportation belts 12 that are examples of transportation portions sandwich a paper sheet B between them so as to transport the paper sheet B. The ribs 21a and 22a that are examples of transportation guides each protrude in a direction of the sandwiched paper sheet B such that the paper sheet B is deformed into a wave shape in the cross section perpendicular to the transportation direction D1, and each extend in the transportation direction D1.

Thus, when a sandwiched paper sheet B is deformed into a wave shape in the transportation direction D1 using transportation guides having a simple configuration such as the ribs 21a and 22a, it is possible to prevent the entire paper sheet B from being deformed in the transportation direction D1, such as the forward end of the paper sheet B being turned up, and to increase the stiffness of the paper sheet B. Thus, the present embodiment makes it possible to prevent a paper sheet B from being jammed or from proceeding obliquely with a simple configuration. Further, when the stiffness of a paper sheet B is increased, it is possible to transport the paper sheet B at a high speed because the paper sheet B is less likely to be deformed due to a wind pressure from a direction opposite to the transportation direction D1. Furthermore, it is possible to increase the stiffness of a paper sheet B without increasing the number of portions between which a paper sheet B is sandwiched or making the area of the sandwiching portions larger, the sandwiching portions being constituted of the transportation rollers 11 and the transportation belts 12. This also permits the paper sheet transportation mechanism 1 and the paper sheet handling device 100 to have a simple configuration.

Further, in the present embodiment, the ribs 21a and 22a each extend, in the transportation direction D1, over a range having a length equal to or longer than the length L1 of a paper sheet B (L3 (the length of the rib 21a, 22a)≥L1 (the length of a paper sheet B)). This results in deforming the entire paper sheet B into a wave shape in the transportation direction D1, and results in the entire paper sheet B having a constant wave shape in the transportation direction D1 (a shape of the cross section perpendicular to the transportation direction D1), so it is possible to further prevent the paper sheet B from being deformed and to further increase the stiffness of the paper sheet B. As a result, it is possible to further prevent a paper sheet B from being jammed or from proceeding obliquely.

Furthermore, in the present embodiment, the rib 21a of the upper guiding plate 21 that is an example of a first transportation guide protrudes in a direction of a paper sheet B from one side (upper side) in the cross section described above, the paper sheet B being situated between the one side and the other side (lower side) in the cross section described above. The rib 22a of the lower guiding plate 22 that is an example of a second transportation guide protrudes in the direction of the paper sheet B from the other side in the cross section described above. This results in ensuring that a paper sheet B will be deformed into a wave shape by the ribs 21a and the ribs 22a that are situated to sandwich the paper sheet B between them. Thus, it is possible to further prevent a paper sheet B from being jammed or from proceeding obliquely.

Moreover, in the present embodiment, a plurality of ribs 21a of the upper guiding plate 21 and a plurality of ribs 22a of the lower guiding plate 22 are arranged in the width direction D2 of a paper sheet B in the cross section described above. At least one of the ribs 21a of the upper guiding plate 21 is arranged between the plurality of ribs 22a of the lower guiding plate 22 in the width direction D2, and at least one of the ribs 22a of the lower guiding plate 22 is arranged between the plurality of ribs 21a of the upper guiding plate 21 in the width direction D2. This results in ensuring that a paper sheet B will be deformed into a wave shape in a range in which the ribs 21a and the ribs 22a are arranged alternately with each other in the width direction D2. Thus, it is possible to further prevent a paper sheet B from being jammed or from proceeding obliquely.

Further, in the present embodiment, a plurality of (two) transportation rollers 11 and a plurality of (two) transportation belts 12 are arranged in the width direction D2, and a plurality of ribs 21a are arranged in the width direction D2 within a region situated between the plurality of transportation rollers 11 and outside of this region, and a plurality of ribs 22a are arranged in the width direction D2 within a region situated between the plurality of transportation belts 12 and outside of this region. This results in ensuring that a paper sheet B sandwiched at a plurality of locations will be deformed into a wave shape. Thus, it is possible to further prevent a paper sheet B from being jammed or from proceeding obliquely.

Furthermore, in the present embodiment, at least one of the rib 21a of the upper guiding plate 21 and the rib 22a of the lower guiding plate 22 protrudes in a direction of a paper sheet B beyond the virtual plane S, including a sandwiching plane in which the paper sheet B is sandwiched between the transportation rollers 11 and the transportation belts 12. This results in ensuring that a paper sheet B will be deformed into a wave shape by the rib 21a, 22a that protrudes in a direction of the paper sheet B beyond the virtual plane S. Thus, it is possible to further prevent, a paper sheet B from being jammed or from proceeding obliquely.

Moreover, in the present embodiment, the rib 21a has the tapered portion 21a-1, 21a-2 formed at at least one of the two ends in the transportation direction D1 such that the protrusion of the rib 21a becomes smaller toward the end, and the rib 22a has the tapered portion 22a-1, 22a-2 formed at at least one of the two ends in the transportation direction D1 such that the protrusion of the rib 22a becomes smaller toward the end. This permits a paper sheet B to easily enter a region in which the ribs 21a and the ribs 22a are arranged, and it is also possible to further prevent a paper sheet B from being jammed when the paper sheet B enters this region.

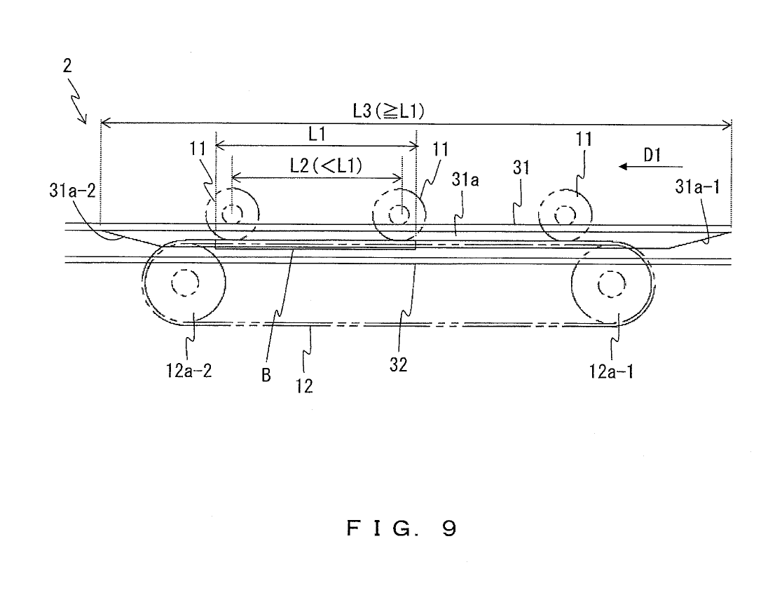

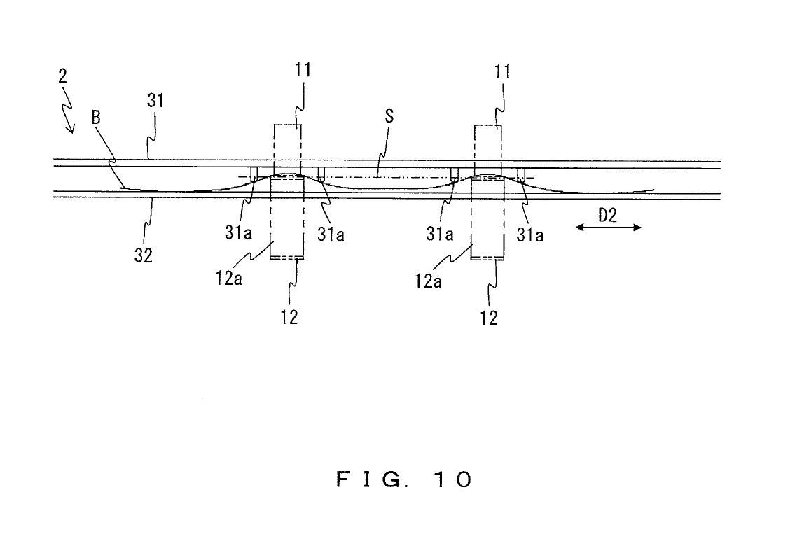

FIGS. 9 and 10 are cross-sectional views of an internal structure of a paper sheet transportation mechanism 2 with a paper sheet B deformed into a wave shape according to a modification of the embodiment described above.

FIG. 10 is a cross-sectional view of the paper sheet transportation mechanism 2 with the paper sheet B deformed into a wave shape, wherein the cross section is perpendicular to the transportation direction D1.

This modification is different from the embodiment described above in that it does not include a rib corresponding to the rib 22a of the lower guiding plate 22 that is illustrated in, for example, FIGS. 3 and 4, but it is similar to the embodiment described above in regard to the other points. Thus, the detailed descriptions are omitted.

An upper guiding plate 31 of the paper sheet transportation mechanism 2 has a rib 31a that is an example of a transportation guide, as in the case of the upper guiding plate 21 of the paper sheet transportation mechanism 1 according to the embodiment described above. On the other hand, with respect to a lower guiding plate 32, a rib corresponding to the rib 22a of the lower guiding plate 22 of the paper sheet transportation mechanism 1 is not formed on it, which is different from the lower guiding plate 22.

As described above, in the cross section illustrated in FIG. 10 that is perpendicular to the transportation direction D1, a paper sheet B can also be deformed into a wave shape only by use of the ribs 31a protruding in a direction of the paper sheet B from one side (upper side), the paper sheet B being situated between the one side and the other side.

The present invention is not limited exactly to the embodiments described above, and may be embodied by modifying components when they are implemented without departing from the spirit of the present invention. Further, various inventions can be made by appropriately combining a plurality of components disclosed in the embodiments described above. For example, all of the components disclosed in the embodiments described above may be appropriately combined. Various modifications and applications may be made without departing from the scope of the invention.

What is claimed is:

1. A paper sheet transportation mechanism comprising:
transportation portions between which a paper sheet is sandwiched so as to transport the paper sheet; and
a transportation guide that protrudes in a direction of the paper sheet sandwiched by the transportation portions such that the paper sheet is deformed into a wave shape in a cross section perpendicular to a transportation direction of the paper sheet, and that extends in the transportation direction.

2. The paper sheet transportation mechanism according to claim 1, wherein
the transportation guide extends, in the transportation direction, over a range having a length that is equal to or longer than a length of the paper sheet.

3. The paper sheet transportation mechanism according to claim 1 comprising a plurality of said transportation guides, wherein
the plurality of transportation guides include a first transportation guide that protrudes in the direction of the paper sheet from one side in the cross section, the paper sheet being situated between the one side and another side in the cross section; and a second transportation guide that protrudes in the direction of the paper sheet from the another side in the cross section.

4. The paper sheet transportation mechanism according to claim 3, wherein
the plurality of transportation guides include a plurality of said first transportation guides and a plurality of said second transportation guides,
the plurality of first transportation guides and the plurality of second transportation guides are arranged in a width direction of the paper sheet in the cross section,
at least one of the plurality of first transportation guides is arranged between the plurality of second transportation guides in the width direction, and
at least one of the plurality of second transportation guides is arranged between the plurality of first transportation guides in the width direction.

5. The paper sheet transportation mechanism according to claim 4, wherein
the transportation portions are arranged in the width direction, and
the plurality of first transportation guides and the plurality of second transportation guides are arranged in the width direction within a region situated between the transportation portions and outside of the region.

6. The paper sheet transportation mechanism according to claim 3, wherein
at least one of the first transportation guide and the second transportation guide protrudes in the direction of the paper sheet beyond a virtual plane including a sandwiching plane in which the paper sheet is sandwiched between the transportation portions.

7. The paper sheet transportation mechanism according to claim 1, wherein
the transportation guide has a tapered portion formed at at least one of two ends in the transportation direction such that the protrusion of the transportation guide becomes smaller toward the end.

8. A paper sheet handling device comprising a paper sheet transportation mechanism that includes
transportation portions between which a paper sheet is sandwiched so as to transport the paper sheet; and
a transportation guide that protrudes in a direction of the paper sheet sandwiched by the transportation portions such that the paper sheet is deformed into a wave shape in a cross section perpendicular to a transportation direction of the paper sheet, and that extends in the transportation direction.
